(19) United States
(12) Patent Application Publication
(10) Pub. No.: US 2009/0232290 A1
(43) Pub. Date: Sep. 17, 2009

(54) Method for Geolocation based on the information from an electronic device compiled by the intelligent selection of accounting data compiled by AAA Protocols.

(76) Inventor: Sebastian Ignacio Herrera Schuvab, Buenos Aires (AR)

Correspondence Address: Sebastian Ignacio Herrera Schuvab, 2185 Fray Santamaria de Oro 2185 1B, Buenos Aires BA, 1425, AR

(21) Appl. No.: 12/406,102

(22) Filed: Mar. 17, 2009

Related U.S. Application Data
(60) Provisional application No. 61/037,287, filed on Mar. 17, 2008.

(51) Int. Cl. H04M 1/00

(52) U.S. Cl. 379/142.1

(57) ABSTRACT

A system to determine the geographical location of an origin electronic device with networking capabilities based on information compiled through AAA protocols. Each data carrier company transmits their accounting data packets to a centralized platform. The Geolocation system analyzes the data and extracts unique information such as IP Address, NAS IP Address and Telephone number. The system matches that information with Geolocation software and communicates geographical positions to Content Provider Companies willing to customize content with a precision expressed in geographical coordinates. The present method shows an important utility for Content Providers and Data Carrier Companies. For Content Provider Companies, it offers the possibility to customize content for a particular electronic device in a precise geographic coordinate at any point in the world. For Data Carrier Companies, the possibility to receive an economic benefit for each geo located connection transmitted to the network and paid for by a content company.

### “CROSS-REFERENCE TO RELATED APPLICATIONS

This application claims Benefit of U.S. Provisional 61/037,287, filed Mar. 17, 2008, the entire contents of which is incorporated herein by its reference.”

### FIELD OF THE INVENTION

This invention relates generally to techniques of geographic location of electronic devices with networking capabilities, using a network of access points. More particularly, it relates to a method of electronic device detection, based on a system that analyzes the information received from Data Carrier Companies through home address Geolocation and accounting data packets generated through AAA protocols. This network of devices, their respective geographic locations and the accounting information generated between a Client and a Server, provides the chance to create a geo location system. This system has the possibility to incorporate and geographically locate telephone based connections, cable modem connections and wireless connections. It has an average precision range from 1 meter to 100 meters.

### BACKGROUND OF THE INVENTION

Analyzing the current situation in the Digital Content Arena, a general situation appears. Online platforms operating as Content Provider Companies use Geolocation services based on IP detection to estimate from where an electronic device is requesting content. Contents are delivered to consumers taking into consideration these analyses, but current Geolocation systems are less precise for a range of precision beyond the Country as a Whole.

Consequently, Content Provider Companies using current Geolocation services either are not in compliance or cannot enhance current services offered to customers through their digital channels. In order to facilitate comprehension, we will explain the geographic detection process of an electronic device among online platforms. When a consumer requests content, Content Provider Companies analyze the information provided by current Geolocation services, customizing their contents for a particular location. Current Geolocation systems use an outside inside approach; by this we mean that they focus on the whole system to detect an IP address in a particular location. In the present situation, Geolocation companies collect information from all over the Internet using collection points, analyzing billions of IP Addresses to detect the geographic location of an electronic device requesting information. These companies use large quantities of mathematic calculations, track network changes and collect information from all over the internet to support their operations. Current Geolocation systems can estimate the geographic location of an electronic device with 99% accuracy for country analyses. But this number decreases to 60-65% when they attempt to estimate that location with a higher range of precision such as a city or postal code. Block geographic estimation or any estimation below 1 mile is not part of the current state of art available in Geolocation services presently. The reason of this limitation resides in a technical situation. Geolocation companies are not incorporating Data Carrier Companies' information in their current analysis. Geolocation analyses are made taking into consideration previous behavior s of Data Carrier Companies routing their data packets with no certainty that they will maintain that network structure in the short term. Based on the fact that Data Carrier Companies can redistribute their packages inside their networks using an internal load balancing system, packages generated in a particular city can display an IP Address usually assigned to customers located in another one. Taking into consideration previous behaviors, a Geolocation system will assign the customer to a location that is not the one where he/she is actually located. As a result, Geolocation systems are less precise when they attempt to estimate the geographic position of electronic devices with a range of precision beyond the country as a whole. Based on this situation, we conclude once again. Content Provider Companies using current Geolocation services either are not in compliance or cannot enhance current services offered to their customers. This current situation is having an impact in their operations and relationships with Content Producer Companies. On internal operations, the current lack of precision makes Content Provider Companies unable to enhance current services offered through their websites, losing competitiveness and increased benefits in their operations. Concerning External Partners, contents are distributed by Content Provider Companies with no precise geographical control generating legal problems with Content producers for their digital rights management.

The current level of accuracy is having an impact on the Digital content management arena. Current IP detection/estimation analysis cannot define the location from where a consumer is accessing the network with geographical coordinate precision. Consequently, to enhance the current level of accuracy it will be necessary to incorporate Broadband Carrier companies' information into the equation. Technically, Data Carrier Companies have the possibility to know the geographic locations of their last mile accesses, based on the proprietary information they handle to run their operations. Knowing the geographic location of the accesses, it is possible to customize content for electronic devices with network capabilities with a precision expressed in meters. Since the beginning of communication networks, Data Carrier Companies operate using AAA protocols in order to grant access to their networks. As a consequence, these protocols provide companies with authorization, authentication and accounting functionalities in order to control consumers' access to their networks. By using these protocols, Data Carrier Companies manage users' access through their clients deployed in the field, transmitting that information to Servers that proceed to approve, deny and/or charge consumers accessing their infrastructure. Three main protocols, Radius—Tacacs+ and Diameter, were developed during the last decades in order to provide these functionalities. Despite that these protocols have their own technical characteristics—as an example Radius communicates using UDP transport while Diameter uses TCP for the same task—all of them share the same kind of working structure providing Data Carrier Companies a standardized layout in order to operate. These standardized procedures and explanations are defined by different RFC notes managed by the Internet Engineering Task Force, making it easy for any data carrier company to deploy this solution in their networks. As it is explained on each RFC Note that defines each protocol, these procedures are used by clients and servers in order to generate the authorization, authentication and accounting of users accessing its networks. Authorization and authentication run together, in the case of radius protocol using port 1812 to transmit their information. Accounting functionalities on radius protocol transmit information directly to the accounting servers using port 1813. The differentiation of the information transmitted permits to work with different servers processing it. Accounting data packets don't show users sensitive information such as passwords, as a consequence we can presume a high possibility of observing Data Carrier Companies sharing that information with the idea to receive an economic benefit. On the other hand, Accounting data packets display information regarding IP Address assigned to the user, NAS IP Address of the server that validates user access, telephone number from where a consumer is accessing the network, accounting session id established with its company. Taking into consideration that fixed telephone lines and cable modem connections are installed in homes and businesses, it becomes possible to match that information with the Geolocation software to assign geographic coordinates to those last mile accesses. Assigning the fixed lines to geographic coordinates, Data Carrier Companies can provide information of the location of a particular electronic device accessing to the internet.

In the case of telephone connections, these companies receive their connections directly from their customers fixed telephone lines. When those customers connect to the ISP, companies know the telephone line accessing their network. Data Carrier Companies make a match using the Username and Password of those users and assign a logical public address to surf the internet. This information makes it possible to develop a Geolocation system with the idea to sell Data Carrier Companies information to Content Provider Companies, who are willing to deliver customized contents with a precision expressed in geographic coordinates. This Geolocation method provides a systemic approach for all Internet participants. Through this system, Data Carrier Companies receive an economic benefit for each geographically located connection that they have transmitted to the system and that a Content Provider Company has paid for. This income contributes to increased investments in networking, expanding the present infrastructure. If they have a greater network, they will receive more money for each geographically detected connection that they generate, obtaining greater benefits for their operations. From the Content Provider's side, the proposed method of analysis provides geographically detected data packages of information. Content Provider Companies that need Geolocation information with the current level of precision will continue to use current systems and pay nothing to Data Carrier Companies. Content Provider Companies requesting a Geolocation system with a higher precision of geographic coordinates pay Data Carrier Companies for the information provided. Consequently, this system appears as the best method, Data Carrier Companies receive an economic benefit for the offered information, information that can only be generated by their contribution being the primary access to the internet and having access to the first pair of unique identifiers. Content Provider Companies will be able to deliver customized content for a particular electronic device in a particular geographic position. Comparing this method with the current state of art, we can infer that the proposed scheme brings some interesting features and advances for participants:
Data Carrier Companies receive an economic retribution for all geographically located packages transmitted to and paid for by Content Provider Companies affiliated to the system.
Content Provider Companies will be able to deliver customized content for a particular electronic device in a particular geographic position.

The proposed method gives the chance to understand a last mile connection as a unique point of information in any place of the world. This point of information has a past and a present giving people that access the internet from those geographic coordinates, the possibility to receive customized content from audiovisual platforms, web information services, advertising and products.

Consequently, the possibility to customize content based on a geographical location expressed in degrees, minutes and seconds, gives Content Providers the chance to enhance the current situation in:
Ad serving with a higher level of precision, with the possibility to incorporate local advertising to the served results. Through the proposed system, advertisers will be able to bid for their ads based on geographical zones expressed in meters.
Search engine content, assigned for particular electronic devices with a higher level of precision, based on the geographical information provided by the Data Carrier Company.
IP address and unique identifier validation for online payment of gateways, thus decreasing online fraud.
Online classifieds providing consumers with access to products located within a range of geographic precision.

### SUMMARY

This invention takes into consideration concepts such as last mile communication access, network operating standards and AAA protocols to develop a Geolocation system. This Geolocation system will provide the possibility to customize content for particular electronic devices with network capabilities, with a precision defined in degrees, minutes and seconds of geographic coordinates anywhere in the world. The proposed invention offers Content Provider Companies with a system that provides the geographical location of an origin electronic device with networking capabilities, based on the information provided by Data Carrier Companies. The proposed layout consists of Data Carrier Companies assigning their last mile connections to geographic coordinates and transmitting data packet information to the system. For Cable Modem Companies, transmitting fixed IP addresses assigned to consumers' home addresses, to a centralized system. For Telephone line companies transmitting their accounting data packets to a centralized system. These companies share their accounting registries with the system in order to allow tracking of the connections generated through their operations. This process is managed by AAA protocols defined by different RFC Notes—in Radius protocol defined by RFC Note 2866 for accounting functionalities—. Given the proposed model of Geo Location, the system will show the following characteristics and participants:
1—Data Carrier Companies will inform, in real time, the geographic positions of the electronic devices that are accessing the Internet. These companies will offer that information with the idea to obtain an economic benefit based on the geographic information offered to those affiliate content platforms.
2—Content Provider Companies affiliated with the system, which paid to receive the information of the geographic location of the origin electronic equipments.
3—A centralized system which will estimate the value per connection, geographically located and transmitted, to be paid to Data Carrier Companies. This estimation will be based on the geographic characteristics from where that information package has been generated.

At an operating level the system will operate through the following process. The Geolocation system processes the telephone lines in each country assigning them respective address Geocoding. Data Carrier Companies register at the Geolocation system the NAS-IP-Addresses of the servers that work on their operations. Data Carrier Companies transmit their Accounting data packets to the Geolocation system. The Geolocation system analyzes the information and extracts the following fields: User-Name/Acct-Session-ID/Framed IP Address/NAS-IP-Address/Calling-Station-ID/Timestamp. The Geolocation system compares this data with the proprietary information it possesses.

For Internet access through telephone lines, the system will have previously geocoded all telephone lines on each country where it operates. Data Carrier Companies will communicate the accounting data packets to the system which will assign them the corresponding Geolocation. For Internet access through cable modem, the system will provide Data Carrier Companies with access to geographic location software to determine the geographical position of their last mile access connections. Through this software, Data Carrier Companies are able to geographically locate their connections with a precision expressed in degrees, minutes and seconds covering the entire world. Content Provider Companies make their affiliation to the system and determine the markets where they want to be enrolled. On the other hand, the system compares the NAS-IP-Address for a connection with the same logical address transmitted by two Data Carrier Companies affiliated to the system, detecting which was the one to have direct communication with the consumer. Finally, the system pays the data carrier company for the geographically located package, if data has been purchased by the destination content company.

Based on the fact that current Geolocation systems vary among carriers, the system will assign Data Carrier Companies to a rate scale based on the registration information and daily operations performed by these participants. The rate scale assigned to a company will depend on:
The relationship between the amounts of Geo located connections that a data carrier uploaded to the system, compared with the total number of Geo localized connections uploaded by all the Data Carrier Companies affiliated in the country.
The number of Geo Located connections offered by Data Carrier Companies and purchased by Content Provider Companies.
The accuracy range measured in meters displayed by Data Carrier Companies based in the connection method.

Finally, it is important to clarify that the privacy of customers inside each company is protected. Data Carrier Companies do not transmit proprietary information about their customers to the system. The system receives only the information of electronic devices with networking functionalities, accessing the internet from a particular location. Data Carrier Companies upload information based on: User-Name/Acct-Session-ID/Framed IP Address/NAS-IP-Address/Calling-Station-ID/Timestamp.

Taking into consideration that DHCP is the common operating procedure to assign a logical address to electronic device, it is clear that the same IP address will appear in different frames of time with different Geographic locations and telephone numbers.

### BRIEF DESCRIPTION OF THE IMAGES

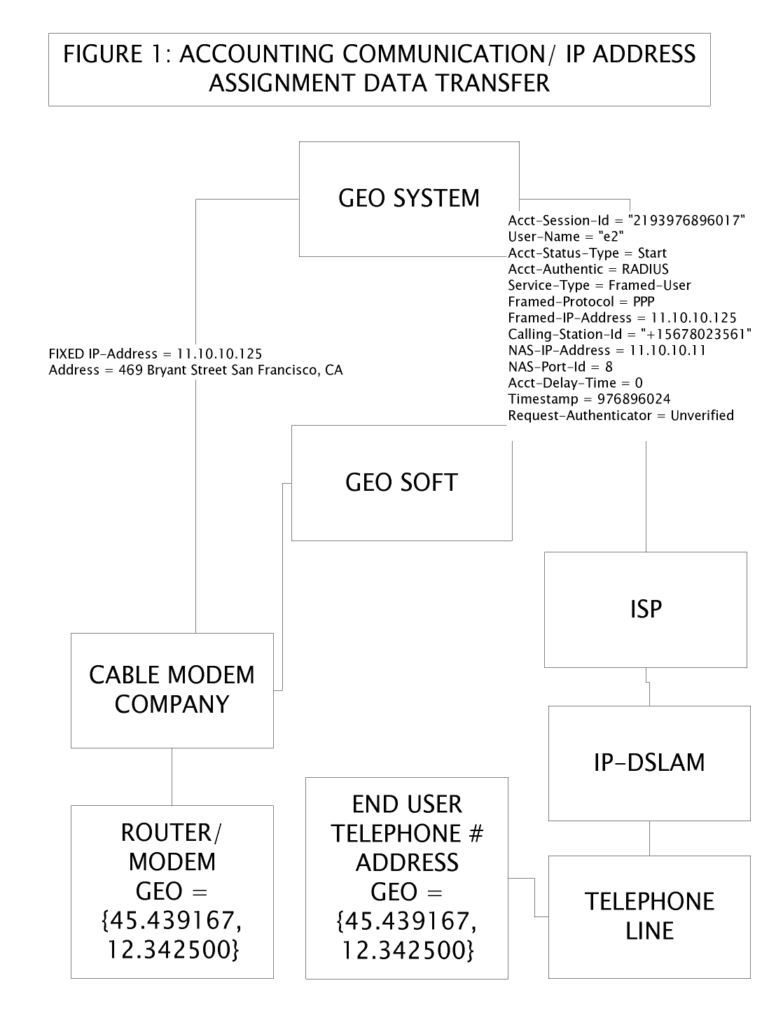

FIG. 1: ACCOUNTING COMMUNICATION/IP ADDRESS ASSIGNMENT DATA TRANSFER, Data Carrier Companies register at the Geolocation system the NAS-IP-Addresses of the servers that work on their operations. Data Carrier Companies transmit their Accounting data packets to the Geolocation system. For Internet access through cable modem, the system will provide Data Carrier Companies with access to geographic location software in order to determine the geographical position of their last mile access connections. Through this software, Data Carrier Companies are able to geographically locate their connections with a precision expressed in degrees, minutes and seconds covering the entire world.

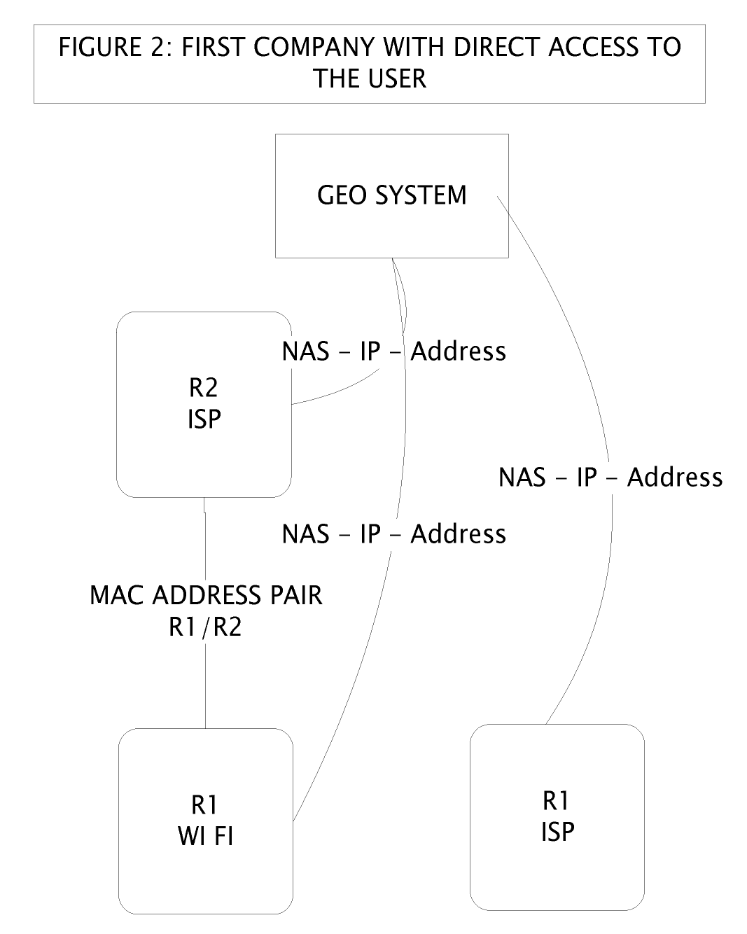

FIG. 2: FIRST COMPANY WITH DIRECT ACCESS TO THE USER The system compares the NAS-IP-Address for a connection with the same logical address transmitted by two Data Carrier Companies affiliated to the system, detecting which was the one to have direct communication with the consumer.

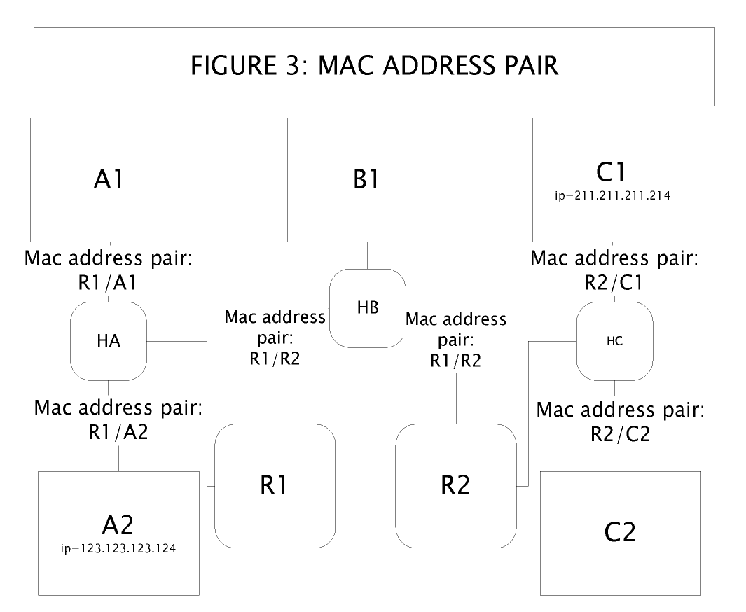

FIG. 3: MAC ADDRESS PAIR The figure shows the communication—and packet data route—between computer A2 and computer C1. The data packet route shows the way physical addresses change on each router hop. Logical addresses remain without changes throughout the entire communication. This circumstance impedes Content Provider Companies to know which electronic device is requesting the information.

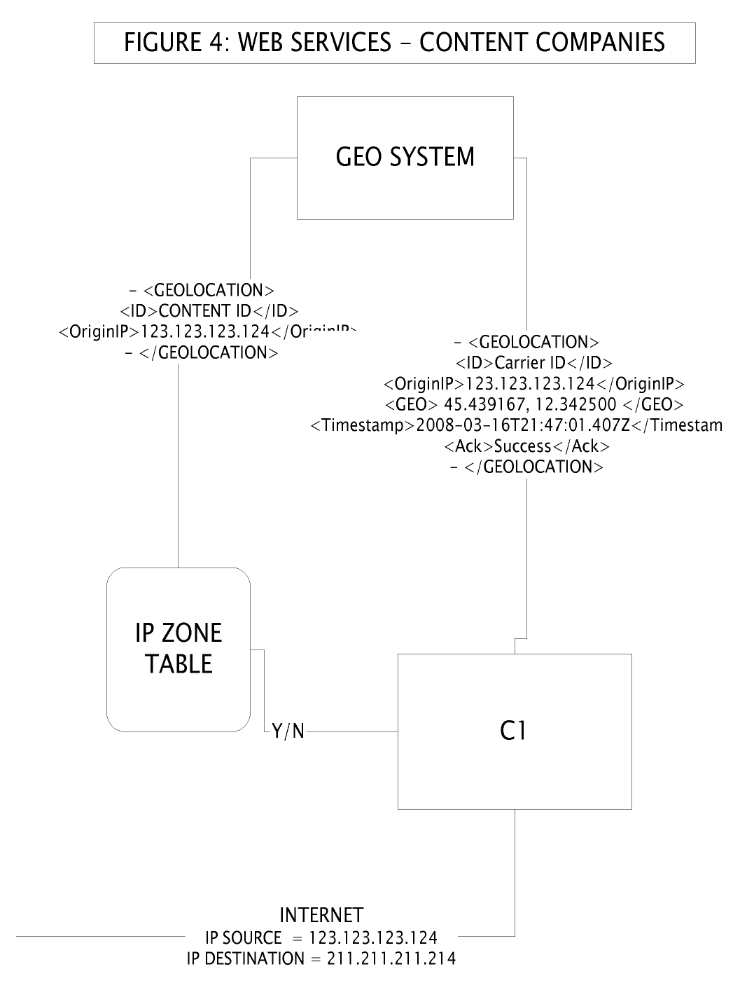

FIG. 4: WEB SERVICES—CONTENT COMPANIES Content Provider Companies make their affiliation to the system and determine the markets where they want to be enrolled. The system offers Content Provider Companies with high traffic volume, a table with IP ranges based on the country affiliations that they made.

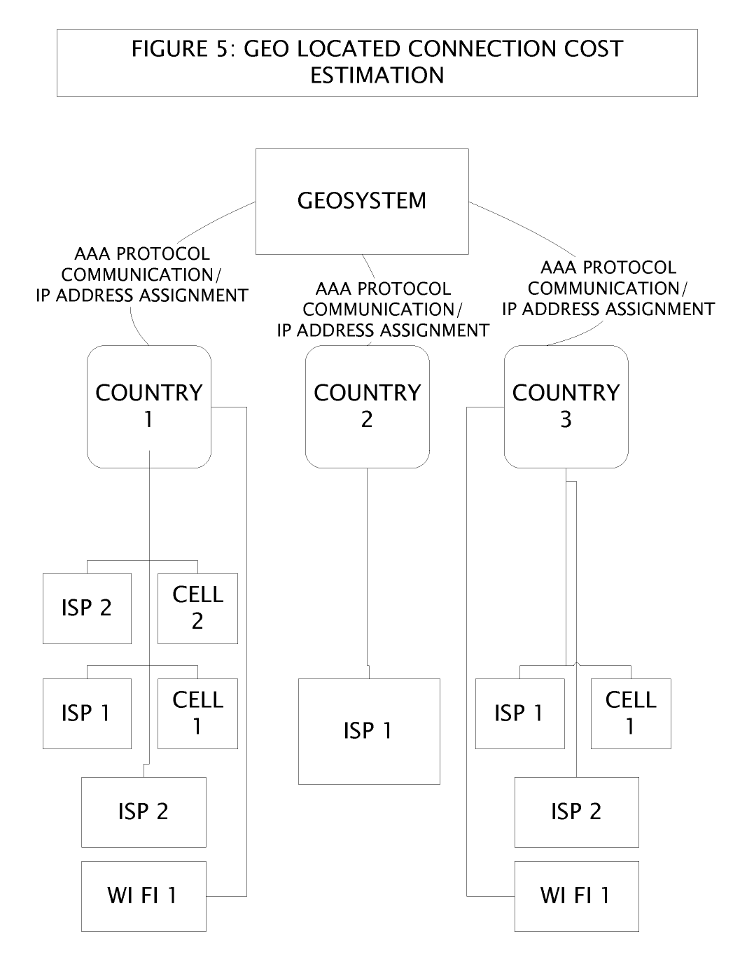

FIG. 5: GEO LOCATED CONNECTION COST ESTIMATION The figure shows the way in which Data Carrier Companies upload the information to the Geo system. Geo system analyzes and estimates a cost per package, based on Country ratio information.

### DETAILED DESCRIPTION OF THE DRAWINGS

FIG. 1: ACCOUNTING COMMUNICATION/IP ADDRESS ASSIGNMENT DATA TRANSFER, For Internet access through cable modem, the system will provide Data Carrier Companies with access to geographic location software to determine the geographical position of their last mile access connections. Through this software, Data Carrier Companies are able to geographically locate their connections with a precision expressed in degrees, minutes and seconds covering the entire world. Data Carrier Companies operating with Telephone lines will communicate the accounting data packets to the system and this one will assign them the corresponding Geolocation. The Geolocation system analyzes the information and extracts the following fields: User-Name/Acct-Session-ID/Framed IP Address/NAS-IP-Address/Calling-Station-ID/Timestamp. The Geolocation system compares this data with the proprietary information it possesses.

Each field represents important data factors for the Geolocation system. Framed IP Address lets us know the IP address—layer 3—assigned to an electronic device requesting access to the internet. NAS-IP-ADDRESS lets us know which was the first data carrier company having a direct relation with an electronic device accessing the internet. Calling-Station-ID lets us know the telephone number from where an electronic device is accessing the Internet. The system assigns its proprietary Geocoding information to said number. Acct-Session-ID lets us know—in conjunction with NAS-IP-Address—the ID of the data carrier company that has a direct relation with an electronic device accessing the internet.

FIG. 2: FIRST COMPANY WITH DIRECT ACCESS TO THE USER The system compares the NAS-IP-Address for a connection with the same logical address transmitted by two Data Carrier Companies affiliated to the system, detecting which was the one to have direct communication with the consumer. The proposed figure shows two examples. In the first one, the Wi Fi community company and the ISP Company affiliated to the system transmit their information to the Geo system. The system compares the NAS-IP-Address for a connection with the same logical addresses. The system assumes that the WI FI community company was the first company to have direct relation with the customers and pays this company for the geographically located package of information. On the second example the ISP Company informs through accounting data packets a particular connection. Based on the fact that it is the only company that transmits the information to the geo system, the system pays the ISP Company.

FIG. 3: MAC ADDRESS PAIR The figure shows the communication—and packet data route—between computer A2 and computer C1. The data package route shows the way physical addresses change on each router hop. Logical addresses remain without changes throughout the entire communication. Using the OSI model to explain the technical aspect, in a communication between two machines: The Third Layer (network): will be responsible for assigning IP Addresses (Logical Addresses) to the data packages being part of the connection. The Second Layer (Data Link): will be responsible for communicating physical addresses of the related machines. These are only a few of the functions each layer has, but in these functions lies the explanation and logic of the system. Data package communicating machines located in different LANs maintain at a layer level 3—network—the same pair of logical addresses—Origin IP source and Destination IP source—from one computer to the other. On the other hand, at a layer 2—Data Link—physical address pairs will be modified on each Hop that the data package performs on each router. Consequently, destination machines will know the logical address of origin devices, but only the physical layer of the last router. The only machine that determines the first pair of physical unique identifiers—such as MAC addresses—will be the first router connecting with the origin computer. The figure shows computer A2 with a logical address 123.123.123.124 and MAC address number 00-1185-83-6B-9B communicating to the computer C1 on network C. Computer C1 shows Destination IP Address 211.211.211.214 with the MAC address 0800-0B-34-3W-1T. Logical addresses remain with the same numbers throughout the entire communication route, but physical addresses change with the hop on each router. Consequently, destination computers only know the logical address of an origin computer requesting information, but not the physical address. This circumstance impedes Content Provider Companies to know which electronic device is requesting the information.

FIG. 4: WEB SERVICES—CONTENT COMPANIES Content Provider Companies make their affiliation to the system and determine the markets where they want to be enrolled. The system offers Content Provider Companies with high traffic volume, a table with IP ranges based on country affiliations that they made. Subscribing to a country means to accept the cost per package estimated. If the origin logical address received by a content provider company doesn't belong to a Country of affiliation, the Web services response will be “Not part of your affiliate zone”. On the other hand, if the logical address belongs to a country were the content company was affiliated, the system will provide information such as the Geographic localization of the origin electronic device. The Geo system communicates: Origin IP, Geo location expressed in geographic coordinate ranges and Timestamp record of the informed connection. If the system doesn't have data carrier information for that particular IP Address, the system serves Geolocation services based on IP address detection as traditional Geo Location Company's offer.

FIG. 5: GEO LOCATED CONNECTION COST ESTIMATION The figure shows the way Data Carrier Companies upload the information to the Geo system. Geo system will assign Data Carrier Companies to a rate scale based on the registration information and daily operations performed by these participants. The rate scale assigned to a company will depend on:
The number of Geo Located connections transmitted to the system over a period of time: The relationship between the amounts of Geo located connections that a data carrier uploaded to the system, compared with the total number of Geo localized connections uploaded by all the Data Carrier Companies affiliated in the country.—The greater the volume the greater the monetary reward will be—
The number of Geo Located connections offered by Data Carrier Companies and purchased by Content Provider Companies.—The greater the infrastructural quantity the greater the monetary reward will be—
The accuracy range measured in meters displayed by Data Carrier Companies based in the connection method.—The greater the quantity of precise geographic locations transmitted to Geo system the greater the monetary reward will be—

What is claimed comprehends:

1. A computer implemented method for carrying out an international geolocation system comprising:
a system to perform the determination of the geographical location of an origin electronic device with networking capabilities, wherein the determination consist on the analysis of the accounting information generated through accounting protocols received from data carrier companies, comparing this accounting data packet information with the proprietary geographic information that the system possesses.

2. The method of claim 1 wherein the determination of the geographical location of an origin electronic device with networking capabilities the system will have previously geographically locate all telephone lines on each country where it operates, wherein data carrier companies will communicate the accounting data packets to the system which will assign them the corresponding geolocation information for a particular internet protocol address.

3. The method of claim 1 wherein the determination of the geographical location of an origin electronic device with networking capabilities the system will have previously geographically locate all last mile accesses on each country where it operates, wherein data carrier companies will communicate the accounting data packets to the system which will assign them the corresponding geolocation information for a particular internet protocol address.

4. The method of claim 1 wherein the determination of the geographical location of an origin electronic device, the system extracts from the accounting data packet the following information:
user-name;
acct-session- id;
framed ip address;
nas - ip - address;
calling - station - id; and
timestamp;
wherein the system matches this data with the proprietary geographic information it possesses to generate the geolocation information.

5. A computer implemented method comprising a centralized environment which will estimate the value per connection, geographically located and transmitted, to be paid to data carrier companies.

6. The method of claim 5 wherein the centralized environment pays the data carrier company for the geographically located package, if data has been purchased by the destination content company.

7. The method of claim 5 wherein the centralized environment provides a comparison of the accounting information generated through data carrier companies, wherein the system compares the nas-ip-address for a connection with the same logical address transmitted by two data carrier companies affiliated to the system, detecting which was the one to have direct communication with the consumer in order to receive the economic benefit.

8. The method of claim 5 wherein the centralized environment gives the functionality to assign data carrier companies to a rate scale based on the registration information and daily operations performed by these participants identifying a weighting factor based on the following premises:
the number of geo located connections transmitted to the system over a period of time;
the relationship between the amounts of geo located connections that a data carrier uploaded to the system, compared with the total number of geo localized connections uploaded by all the data carrier companies affiliated in the country; and
the accuracy range measured in meters displayed by data carrier companies based in the connection method.
